(19) United States
(12) Patent Application Publication
(10) Pub. No.: US 2015/0011393 A1
(43) Pub. Date: Jan. 8, 2015

(54) METHOD FOR INTRODUCING FLORIGEN

(71) Applicant: NATIONAL UNIVERSITY CORPORATION NARA INSTITUTE OF SCIENCE AND TECHNOLOGY, Ikoma-shi (JP)

(72) Inventors: Hiroyuki Tsuji, Ikoma-shi (JP); Ko Shimamoto, Ikoma-shi (JP); Ken-ichiro Taoka, Ikoma-shi (JP); Haruhiko Washida, Ikoma-shi (JP)

(21) Appl. No.: 14/375,416

(22) PCT Filed: Feb. 8, 2013
(86) PCT No.: PCT/JP2013/053043

§ 371 Date: Jul. 29, 2014

(30) Foreign Application Priority Data
Feb. 8, 2012 (JP) 2012-024958

(51) Int. Cl. A01N 37/46

(52) U.S. Cl. CPC A01N 37/46
USPC 504/171

(57) ABSTRACT

The present invention relates to a method of introducing a florigen into a cell of a shoot apical tissue of a plant using a cell-penetrating peptide. More specifically, the present invention relates to a method of introducing a florigen into a cell of a shoot apical tissue of a plant, the method including the step of bringing a solution for florigen introduction containing a florigen and a cell-penetrating peptide in one solvent into contact with a shoot apical tissue of a plant. The present invention also relates to an agent for introducing a florigen into a cell of a shoot apical tissue of a plant, including a florigen and a cell-penetrating peptide, and to a kit for introducing a florigen into a cell of a shoot apical tissue of a plant.

### TECHNICAL FIELD

The present invention relates to a method of introducing a florigen into a cell of a shoot apical tissue of a plant using a cell-penetrating peptide, and to an agent for introducing florigen into cells of a shoot apical tissue of a plant.

The present application claims priority from Japanese Patent Application No. 2012-024958, which is incorporated herein by reference.

### BACKGROUND ART

In order to enhance competitiveness in agricultural production such as food production, production of chemical substances, or biomass production, a technology for controlling flowering of plants is essential. The major technologies for controlling flowering involve those based on an environmental control or a genetic modification. However, the flowering time regulation based on the environmental control cannot be applied universally to various crops or plant species that show lower responsiveness to environmental changes (for example, day length or temperature) or larger-size plant species. Further, in the control of the flowering based on the genetic modification, various crops have been improved by crossing cultivars or genetic engineering technique, but the technology has problems in that: it takes a long time (10 years or more) to create a desirable breed variety; high-quality genetic resources are insufficient; linkage of undesirable characteristics is hard to be avoided; and in some plant species genetic transformation is still difficult to produce transgenic crop.

A florigen is proposed as a universal flowering-determining molecule in plants, and in recent years, the actual molecule of the florigen has been found to be a protein. The florigen is synthesized in a leaf, moves for a long distance up to shoot apices in a plant body, and initiates formation of a flower bud when the florigen reaches the shoot apices. The florigen was considered to be a low-molecular-weight compound when the presence of the florigen was first proposed, and hence it was considered that formation of a flower bud could be induced by treating a plant with the florigen. However, in fact, the florigen is a spherical protein having a molecular weight of about 22,000 and cannot permeate a cell membrane because of its size. Therefore, it is considered that, even if the florigen itself is used for treatment of a plant, the effect cannot be exhibited.

In order to control the flowering of a plant using the florigen, genes coding for the florigen have been isolated (Patent Literature 1, Non Patent Literature 1). The following uses of the genes coding for the florigen have been reported: ear emergence was promoted in rice transformed with the gene coding for the florigen as compared to untransformed rice (Patent Literature 1); and the timing of the flowering was controlled by introducing a mutation into Hd3a, which is one of the genes coding for the florigen (Non Patent Literature 2). In addition, Non Patent Literature 3 discloses that delay of the flowering was observed in a plant transformed with a homolog of TFL1 gene, which is considered as an antagonistic factor against the florigen. Patent Literature 3 reports that CiFT2 protein was expressed using a citrus unshiu-derived gene having high homology to Arabidopsis FT gene, and that the CiFT2 protein was injected into the xylem obtained by cutting a branch of hardy orange. However, in all Examples of Patent Literature 3, it is clearly stated that there is no fact that the treatment with the CiFT2 protein has promoted flower setting. That is, Patent Literature 3 clearly states that, even in a plant not treated with the CiFT2 protein, the flower setting was observed as is the case with the plant treated with the CiFT2 protein (paragraphs 0128 and 0139 in Patent Literature 3). In addition, Patent Literature 3 does not confirm or disclose whether the CiFT2 protein can act as the florigen or not, and whether the CiFT2 protein has been appropriately introduced into a plant body or not.

There have been reported methods of introducing a protein such as a fluorescent protein directly into animal cells or plant cells. One of the methods is a technology using a cell-penetrating peptide (Patent Literature 2, Non Patent Literatures 4 and 5). Non Patent Literature 4 discloses that a fluorescent protein has been introduced into cultured plant cells using a cell-penetrating peptide. Patent Literature 2 discloses that a fluorescent protein or the like has been introduced into various tissues of wheat and the like using a cell-penetrating peptide, and Non Patent Literature 5 discloses that a fluorescent protein has been introduced into the root of onion using a cell-penetrating peptide. However, there is no report that a functional protein specific to a plant such as the florigen has been introduced directly into a tissue of a plant using a cell-penetrating peptide, and that the protein introduced has acted in the plant body.

### CITATION LIST

### Patent Literature

[PTL 1] WO 2002/042475 A1
[PTL 2] JP 2010-532159 A
[PTL 3] WO 2011/059051 A1

### Non Patent Literature

[NPL 1] Tamaki S et al. Science 2007 May 18; 316(5827): 1033-1036.
[NPL 2] Taoka K.-I. et al Nature 2011 476:332-335.
[NPL 3] Nakagawa M et al. Plant J. 2002 29:743-750.
[NPL 4] Zonin et al. Plant Cell Physiol. 52:2225-2235
[NPL 5] Wang H Y et al. Biochemical and Biophysical Research Communications 346 (2006) 758-767

### SUMMARY OF INVENTION

### Technical Problem

An object of the present invention is to provide a method of introducing a florigen into a cell of a shoot apical tissue of a plant.

### Solution to Problem

The inventors of the present invention have made intensive studies to accomplish the object, and as a result, have found that a cell-penetrating peptide can be used to introduce a protein of a florigen that is a universal flowering promoting factor directly into a shoot apical tissue where flowering occurs, and that the florigen can promote flowering, thus completing the present invention.

That is, the present invention includes the following.

1. A method of introducing a florigen into a cell of a shoot apical tissue of a plant using a cell-penetrating peptide.
2. An introduction method according to the above-mentioned item 1, in which the cell-penetrating peptide is selected from a peptide including from 8 to 12 consecutive arginine residues and a peptide having an RXLR sequence.
3. An introduction method according to the above-mentioned item 1 or 2, in which the florigen includes a mutated florigen having an amino acid sequence set forth in SEQ ID NO: 1 with a substitution of at least one amino acid selected from amino acids corresponding to lysine at position 31, cysteine at position 43, glutamic acid at position 57, cysteine at position 109, tyrosine at position 136, tryptophan at position 140, and cysteine at position 166, or a partial peptide thereof.
4. An introduction method according to any one of the above-mentioned items 1 to 3, in which the florigen includes a mutated Hd3a protein having an amino acid sequence set forth in SEQ ID NO: 1 with a substitution of from 1 to 10 amino acids, or a partial peptide thereof.
5. An introduction method according to any one of the above-mentioned items 1 to 4, in which the florigen is selected from the following mutated florigens (1) to (5):
(1) a mutated Hd3a having an amino acid sequence set forth in SEQ ID NO: 1 with substitutions of lysine at position 31 and glutamic acid at position 57;
(2) a mutated Hd3a having an amino acid sequence set forth in SEQ ID NO: 1 with substitutions of cysteine at position 43, cysteine at position 109, and cysteine at position 166;
(3) a partial peptide of the mutated Hd3a described in (2), which includes a sequence of amino acids at from position 6 to position 170 in the amino acid sequence set forth in SEQ ID NO: 1;
(4) a mutated Hd3a having an amino acid sequence set forth in SEQ ID NO: 1 with substitutions of lysine at position 31, tyrosine at position 136, and tryptophan at position 140; and
(5) a partial peptide of the mutated Hd3a described in (4), which includes a sequence of amino acids at from position 8 to position 170 in the amino acid sequence set forth in SEQ ID NO: 1.
6. An introduction method according to any one of the above-mentioned items 1 to 5, including the step of bringing a mixed solution obtained by mixing the florigen and the cell-penetrating peptide in an aqueous medium into contact with the shoot apical tissue of the plant.
7. An introduction method according to the above-mentioned item 6, in which a molar ratio of the florigen and the cell-penetrating peptide in the mixed solution is from 1:1 to 1:50.
8. An introduction method according to the above-mentioned item 6 or 7, in which the aqueous medium has a pH of from 6.5 to 8.0.
9. An introduction method according to any one of the above-mentioned items 6 to 8, in which the aqueous medium includes phosphate buffered saline (PBS).
10. A promotion method for flowering of a plant, the promotion method including using the method according to any one of the above-mentioned items 1 to 9.
11. An agent for introducing a florigen into a cell of a shoot apical tissue of a plant, the agent including: a florigen; and a cell-penetrating peptide.
12. An agent for introducing a florigen according to the above-mentioned item 11, in which the agent includes a mixed solution obtained by mixing the florigen and the cell-penetrating peptide in an aqueous medium.
13. An agent for promoting flowering of a plant, the agent including the agent for introducing a florigen according to the above-mentioned item 11 or 12.
14. A kit for introducing a florigen into a cell of a shoot apical tissue of a plant, the kit including: a florigen; and a cell-penetrating peptide.

### Advantageous Effects of Invention

According to one embodiment of the present invention, it is possible to introduce the florigen directly into the shoot apical tissue where flowering occurs to achieve the flowering-promoting function of the florigen in the shoot apical tissue. According to the introduction method of the present invention, the florigen can be introduced at efficiency as high as 250 times that in a related-art method. The introduction method of the present invention can be applied to a plant species having difficulty in undergoing hybridization breeding or genetic recombination and can be universally used for many plant species. In addition, the size of a plant species into which the florigen is to be introduced is not limited, and the introduction method can be applied outdoors and indoors. Further, the introduction method of the present invention is useful because the method does not require a long-term technical training unlike genetic recombination or the like and can be carried out easily by any person.

### BRIEF DESCRIPTION OF DRAWINGS

FIG. 1 are photographs showing results obtained by examining efficiency of introduction of GFP into rice radicles using various cell-penetrating peptides (Example 1).

FIGS. 2A-2D are graphs showing results obtained by examining efficiency of introduction of GFP into rice radicles, rice protoplasts, tobacco leaves, and Arabidopsis leaves using various cell-penetrating peptides (Example 1).

FIGS. 3A and 3B are graphs each showing results obtained by examining effects of a molar ratio of GFP and a cell-penetrating peptide in a mixed solution on the efficiency of introduction of GFP (Example 1).

FIG. 4 are photographs showing results obtained by examining effects of the kind and pH of buffers in mixed solutions on efficiency of introduction of GFP (Example 1).

FIG. 5 is a photograph showing results of separation of mHd3a-1 capable of high level expression by SDS-PAGE (Example 2).

FIG. 6 is a graph showing results of an analysis of florigen functions of various mutated Hd3a's capable of high level expression (Example 2).

FIG. 7 are photographs showing results obtained by examining efficiency of introduction of GFP in introduction of GFP into a rice shoot apical tissue using a cell-penetrating peptide (Comparative Example 1).

FIG. 8 are photographs showing localization of a florigen in introduction of the florigen into a rice shoot apical tissue using a cell-penetrating peptide (Example 3).

FIG. 9 are photographs showing results of introduction of a florigen into shoot apical tissues of corn and Arabidopsis using a cell-penetrating peptide (Example 4).

FIG. 10 is a graph showing results obtained by examining expression of a flower-bud formation marker gene in introduction of a florigen into a shoot apical tissue of wild-type rice (Example 5).

FIG. 11 is a graph showing results obtained by examining expression of a flower-bud formation marker gene in introduction of a florigen into a shoot apical tissue of rice in which florigens have been inactivated (Example 5).

FIG. 12 are photographs of an Arabidopsis flower bud induced by direct introduction of a florigen (Example 6).

FIG. 13 is a graph showing effects of promoting formation of a flower bud in direct introduction of a florigen into Arabidopsis (Example 6).

FIG. 14 are graphs showing effects on induction of expression of a flowering-responsive gene in direct introduction of a florigen into Arabidopsis (Example 7).

### DESCRIPTION OF EMBODIMENTS

The present invention is directed to a method of introducing a florigen into a cell of a shoot apical tissue of a plant using a cell-penetrating peptide.

In the present invention, the plant refers to a higher plant in which the florigen can act as a factor for promoting flowering. In general, the plant has a vegetative growth stage and a reproductive growth stage, and forms a flower bud upon transition of the growth phase from the vegetative growth to the reproductive growth. The phenomenon of transition from the vegetative growth to the reproductive growth is referred to as “flowering”. For example, the flowering in a monocotyledon such as rice or wheat is ear emergence, and the ear emergence is a phenomenon in which an ear appears from a leaf sheath of a flag leaf by rapidly extending an internode (neck of spike) under a spike. The ear emergence is defined as a time when an ear tip appears in rice or as a time when the base of a spike completely appears in wheat. In addition, the flowering in a dicotyledon, Arabidopsis, is bolting, and a phenomenon in which extraction of rosette leaves is stopped to initiate extension of the scape is referred to as flowering.

The plant in the present invention may be a monocotyledon or a dicotyledon, or may be a short-day plant that forms a flower bud when the hours of daylight per day is shorter than a predetermined time period, a long-day plant that forms a flower bud when the hours of daylight per day is longer than a predetermined time period, or a day-neutral plant, the flowering of which is not affected by the hours of daylight per day. Specific examples of the plant in the present invention include a plant belonging to the family Brassicaceae, a plant belonging to the family Gramineae, a plant belonging to the family Solanaceae, a plant belonging to the family Leguminosae, a plant belonging to the family Rosaceae, a plant belonging to the family Rutaceae, and a plant belonging to the family Anacardiaceae. Examples of the plant belonging to the family Brassicaceae include Arabidopsism, cabbage, and napa cabbage. Examples of the plant belonging to the family Gramineae include corn, rice, wheat, and barley. Examples of the plant belonging to the family Solanaceae include tobacco and tomato. An example of the plant belonging to the family Leguminosae is soybean. Examples of the plant belonging to the family Rosaceae include various rose garden varieties, strawberry, apple, and almond. Examples of the plant belonging to the family Rutaceae include orange, kumquat, and hardy orange. An example of the plant belonging to the family Anacardiaceae is mango. The plant in the present invention is preferably a plant belonging to the family Gramineae or a plant belonging to the family Brassicaceae, more preferably rice or Arabidopsis.

The flowering occurs in a shoot apical tissue (meristem) of a plant. The shoot apical tissue is an apical meristem of a plant body and is present at the peripheral part of a stem. In the shoot apical tissue, new cells are born at all times by cell division to form tissues such as stems, leaves, and flower buds. When the plant undergoes transition from the vegetative growth to the reproductive growth, the shoot apical tissue is converted into an inflorescence meristem to initiate formation of a flower bud. The florigen is considered to be transported from the leaf to the shoot apical tissue and to induce the flowering in the shoot apical tissue.

In the present invention, the florigen is not particularly limited, and examples thereof include rice Hd3a (Os06g0157700) (Genbank Accession No. BAB61028: derived from Oryza sativa Japonica group cultivar Nipponbare), rice RFT1 (Genbank Accession No. AB062676), Arabidopsis FT (Genbank Accession No. AB027504), Arabidopsis TSF (Genbank Accession No. AB027506), tomato SFT (Genbank Accession No. AY186735), and wheat VRN3 (Genbank Accession No. LOC100037541). Of those, rice Hd3a is preferred. In addition, the florigen in the present invention can be obtained by expressing a high level of the florigen by a genetic recombination technology and purifying the florigen, and is preferably one that is highly soluble and has a function of a flowering promoting factor. An example of the florigen is a mutated florigen obtained by introducing a mutation of a substitution of from 1 to 10 (preferably from 1 to 7, more preferably from 1 to 3) amino acids in an amino acid moiety exposed on the outer surface of the florigen, or a partial peptide of the mutated florigen. Examples of the amino acid moiety exposed on the outer surface of the florigen include amino acids corresponding to lysine at position 31, cysteine at position 43, glutamic acid at position 57, cysteine at position 109, tyrosine at position 136, tryptophan at position 140, and cysteine at position 166 in the amino acid sequence set forth in SEQ ID NO: 1. In the present invention, the “site of a protein corresponding to a specific amino acid (such as lysine at position 31) in SEQ ID NO: X” is meant to encompass, in addition to the site of a specific amino acid (such as lysine at position 31) in SEQ ID NO: X, a site corresponding to the specific amino acid (such as lysine at position 31) in a protein having an amino acid sequence other than SEQ ID NO: X and having a function equivalent to that of the protein of SEQ ID NO: X.

The mutated florigen obtained by introducing an amino acid substitution to a florigen or a partial peptide thereof is preferably mutated Hd3a or a partial peptide thereof, more preferably any of the following mutated florigens (1) to (5):

(1) a mutated florigen having an amino acid sequence set forth in SEQ ID NO: 1 with substitutions of amino acids corresponding to lysine at position 31 and glutamic acid at position 57;
(2) a mutated florigen having an amino acid sequence set forth in SEQ ID NO: 1 with substitutions of amino acids corresponding to cysteine at position 43, cysteine at position 109, and cysteine at position 166;
(3) a partial peptide of the mutated florigen described in (2), which includes an amino acid sequence corresponding to a sequence of amino acids at from position 6 to position 170 in the amino acid sequence set forth in SEQ ID NO: 1;
(4) a mutated florigen having an amino acid sequence set forth in SEQ ID NO: 1 with substitutions of amino acids corresponding to lysine at position 31, tyrosine at position 136, and tryptophan at position 140; and
(5) a partial peptide of the mutated florigen described in (4), which includes an amino acid sequence corresponding to a sequence of amino acids at from position 8 to position 170 in the amino acid sequence set forth in SEQ ID NO: 1.

In the present invention, as the mutated Hd3a or the partial peptide thereof, the one described in (1), (3), or (5) is preferably used, and the one described in (1) is more preferably used.

Specific examples of the mutated florigens (1) to (5) include various mutated Hd3a's described in Examples below, such as mHd3a-1 (full-length, having K31A and E57A amino acid substitutions), mHd3a-2T (a partial peptide having a sequence consisting of amino acids at positions from 6 to 170, having C43L, C109S, and C166S amino acid substitutions), or a partial peptide of the mutated Hd3a, i.e., mHd3a-3T (a partial peptide having a sequence consisting of amino acids at positions from 8 to 170, having K31A, Y136A, and W140A amino acid substitutions), mHd3a-2F (full-length, having C43L, C109S, and C166S amino acid substitutions), and m-Hd3a-3F (full-length, having K31A, Y136A, and W140A amino acid substitutions).

The cell-penetrating peptide refers to a peptide having cell membrane permeability, and is classified based on chemical properties into three groups including a peptide characterized by containing many basic amino acids (in particular, arginine and lysine), an amphiphilic peptide, and a peptide having an RXLR sequence. Examples of the cell-penetrating peptide may include Tat (SEQ ID NO: 2), FHV coat (SEQ ID NO: 3), Pep-1 (SEQ ID NO: 4), Penetratin (SEQ ID NO: 5), Transportan (SEQ ID NO: 6), R9 (SEQ ID NO: 7), KALA (SEQ ID NO: 8), Avr1b (SEQ ID NO: 9), gp41 (SEQ ID NO: 11), Rev (SEQ ID NO: 22), pAntp (SEQ ID NO: 10), VP22 (SEQ ID NO: 13), SV40NLS (SEQ ID NO: 12), Integrin 133 (SEQ ID NO: 14), Influenza HA-2 (SEQ ID NO: 15), R/W (SEQ ID NO: 18), BMV-gag (SEQ ID NO: 16), HTLV-II Rex (SEQ ID NO: 17), Human cFOS (SEQ ID NO: 19), Human cJUN (SEQ ID NO: 20), and Yeat GCN4 (SEQ ID NO: 21) (see Table 1 and Table 2 below). In the present invention, the cell-penetrating peptide is preferably selected from an arginine-rich peptide (preferably, a peptide including from 8 to 12 consecutive arginine residues) and a peptide having an RXLR sequence. The peptide including from 8 to 12 consecutive arginine residues is most preferably a peptide including 9 consecutive arginine residues (R9). The peptide having an RXLR sequence is most preferably Avr1b.

TABLE 1

| | | Chemical | |
|---|---|---|---|
| Name | Sequence | properties | Characteristics |
| Tat | YGRKKRRQRRR | Arginine-rich | Derived from Tat |
| | (SEQ ID NO: 2) | | protein of HIV |
| | | | virus |
| FHV coat | RRRRNRTRRNRRRVR | Arginine-rich | Derived from |
| | (SEQ ID NO: 3) | | coat protein of |
| | | | FHV virus |
| Pep-1 | KETWWETWWTEWSQPKKKRKV | Amphiphilic | Artificially |
| | (SEQ ID NO: 4) | | designed |
| | | | sequence |
| Penetratin | RQIKIWFQNRRMKWKK | Arginine and | Derived from |
| | (SEQ ID NO: 5) | lysine-rich | Drosophila |
| | | | Antennapedia |
| | | | protein |
| Transportan | GWTLNSAGYLLGKINLKALAA | Amphiphilic | Derived from |
| | LAKKIL (SEQ ID NO: 6) | | neuronal |
| | | | protein galanin |
| R9 | RRRRRRRRR | Arginine-rich | Artificially |
| | (SEQ ID NO: 7) | | designed |
| | | | sequence |
| KALA | WEAKLAKALAKALAKHLAKALA | Amphiphilic | Artificially |
| | KALKACEA | | designed |
| | (SEQ ID NO: 8) | | sequence |
| Avr1b | TEYSDETNIAMVESPDLVRRSLRN | Having RXLR | Derived from |
| | GDIAGGRFLRAHEEDDAGERT | sequence | potato |
| | (SEQ ID NO: 9) | | phytophthora |
| | | | effector protein |

TABLE 2

| Name | Sequence | Characteristics | Derivation |
|---|---|---|---|
| p-Antp | RQIKIWFQNRRMKWKK | Amphiphilic | Derived from |
| | (SEQ ID NO: 10) | | Drosophila |
| | | | transcription |
| | | | factor |
| gp41 | GALFLGFLGAAGSTMGA | Amphiphilic | Derived from |
| | (SEQ ID NO: 11) | | glycoprotein 41 |
| SV40NLS | PKKKRKV | Arginine-rich | Derived from |
| | (SEQ ID NO: 12) | | Simian Virus 40 |
| | | | nuclear transport |
| | | | signal sequence |
| VP22 | DAATATRGRSAASRPTERPRAP | Arginine-rich | Derived from |
| | ARSASRPRRPVD | | herpes simplex |
| | (SEQ ID NO: 13) | | virus VP22 protein |
| Integrin β3 | VTVLALGALAGVGVG | Amphiphilic | Derived from |
| | (SEQ ID NO: 14) | | Integrin β3 |
| | | | protein |
| Influenza | WEAKLAKALAKALAKHLAKALA | Lysine-rich | Derived from |
| HA-2 | KALKACEA | | influenza virus |
| | (SEQ ID NO: 15) | | HA protein |
| BMV-gag | KMTRAQRRAAARRNRWTA | Arginine-rich | Derived from |
| | (SEQ ID NO: 16) | | brome mosaic |
| | | | virus (BMV) Gag |
| | | | protein |
| HTLV-II Rex | TRRQRTRRARRNR | Arginine-rich | Derived from |
| | (SEQ ID NO: 17) | | human T-cell |
| | | | lymphotrophic |
| | | | virus (HTLV)-II |
| | | | Rex protein |
| R/W | RRWWRRWRR | Arginine-rich | Artificially |
| | (SEQ ID NO: 18) | | designed |
| | | | peptide |
| Human c Fos | KRRIRRERNKMAAAKSRNRRRE | Arginine-rich | Derived from |
| | LTDTGC (SEQ ID NO: 19) | | human cFOS |
| | | | protein |
| Human c Jun | RIKAERKRMRNRIAASKSRKRK | Arginine-rich | Derived from |
| | LERIARGC | | human cJun |
| | (SEQ ID NO: 20) | | protein |
| Yeast GCN4 | KRARNTEAARRSRARKLQRMKQ | Arginine-rich | Derived from |
| | GC (SEQ ID NO: 21) | | yeast |
| | | | transcription |
| | | | factor |
| Rev | TRQARRNRRRRWRERQR | Arginine-rich | HIV rev protein |
| | (SEQ ID NO: 22) | | |

The introduction method of the present invention may include the step of bringing the florigen into contact with the shoot apical tissue of the plant in a state where the florigen and the cell-penetrating peptide coexist. The state where the florigen and the cell-penetrating peptide coexist may be a state where the florigen and the cell-penetrating peptide are present in the same solvent. The florigen and the cell-penetrating peptide may be present in a solvent as independent molecules, or the florigen and the cell-penetrating peptide may be present in a solvent as one molecule including the florigen and the cell-penetrating peptide, such as a fusion protein. The introduction method of the present invention preferably includes the step of bringing the florigen and cell-penetrating peptide in a state where the florigen and the cell-penetrating peptide are present in one solvent as independent molecules, that is, a solution obtained by mixing the florigen and the cell-penetrating peptide in an aqueous medium into contact with the shoot apical tissue of the plant. It should be noted that, in this description, the solution containing the florigen and the cell-penetrating peptide in one solvent is referred to as “solution for florigen introduction”.

An example of the molecule including the florigen and the cell-penetrating peptide is a fusion protein. The fusion protein can be prepared by a hitherto known method, and can be obtained by introducing a gene obtained by fusing a gene coding for the florigen and a gene coding for the cell-penetrating peptide into a cell of a host such as yeast or Escherichia coli, expressing the fusion protein in the cell, and isolating and purifying the fusion protein. The amino acid substitution in the florigen can be introduced by a site-directed mutagenesis method well known to a person skilled in the art, and may be introduced using a commercially available kit or the like (such as QuikChange™ Site-Directed Mutagenesis Kit (STRATAGENE)).

In the case where the florigen and the cell-penetrating peptide are prepared as independent molecules, the cell-penetrating peptide to be used can be obtained by chemical synthesis through the use of a hitherto known technology or may be a commercial available product.

The florigen is preferably obtained by, through the use of a hitherto known technology, introducing a gene coding for the florigen into a cell of a host such as yeast or Escherichia coli, expressing the florigen in the cell, and isolating and purifying the florigen. A peptide fragment may be added to the florigen so as not to affect the function of the florigen depending on the expression system of the host cell. For example, in the case of using the expression system of Escherichia coli, a peptide fragment (GPGHM) derived from an Escherichia coli expression plasmid is added to the N-terminal of the protein. The amino acid substitution in the florigen can be introduced by a site-directed mutagenesis method well known to a person skilled in the art, and may be introduced using a commercially available kit or the like (such as QuikChange™ Site-Directed Mutagenesis Kit (STRATAGENE)).

The solution for florigen introduction including the florigen and the cell-penetrating peptide as independent molecules can be prepared by mixing the resultant florigen and cell-penetrating peptide in a solvent. The solution thus prepared is referred to as “mixed solution of the florigen and the cell-penetrating peptide” (sometimes simply referred to as “mixed solution”).

The amounts of the florigen and the cell-penetrating peptide in the solution for florigen introduction are as follows from the viewpoint of efficiency of introduction of the florigen. When the molar amount of the florigen is defined as 1, the molar amount of the cell-penetrating peptide is required to be 1 or more. The molar ratio of the florigen and the cell-penetrating peptide in the mixed solution is preferably from 1:1 to 1:50, more preferably from 1:1 to 1:10.

The final concentration of the florigen in the solution for florigen introduction is preferably from 5 to 500 μM, more preferably from 10 to 100 μM. The final concentration of the cell-penetrating peptide in the mixed solution is preferably from 5 to 5,000 μM, more preferably from 10 to 1,000 μM. When the concentrations of the florigen and the cell-penetrating peptide in the solution for florigen introduction are too high, an osmotic stress may be generated to damage cells of the plant, which is not preferred.

The solvent in the solution for florigen introduction is preferably an aqueous medium. The aqueous medium refers to water or an aqueous solution such as a buffer. The aqueous medium to be used in the present invention is preferably a buffer. The buffer encompasses acetate buffer, phosphate buffer, citrate buffer, borate buffer, tartrate buffer, Tris buffer, phosphate buffered saline (PBS), and the like, and further encompasses a medium to be generally used for cell culture, such as Murashige and Skoog medium (MS medium). Phosphate buffered saline (PBS) or a solution obtained by diluting the PBS to any concentration up to one-tenth of the concentration of the PBS is preferably used as the aqueous medium of the present invention from the viewpoint of efficiency of introduction of the florigen. More preferably, there is used PBS having a composition of 137 mM NaCl, 2.7 mM KCl, 10 mM Na₂HPO₄, and 1.76 mM KH₂PO₄ or a solution obtained by diluting the PBS to any concentration up to one-tenth of the concentration of the PBS. The degree of the dilution only needs to be suited for growth of the plant, and the PBS having the composition is preferably diluted to a concentration of from one-fifth to one-tenth of the concentration of the PBS. In addition, the aqueous medium has a pH of preferably from 5.8 to 9.0, more preferably from 6.5 to 8.0, from the viewpoint of efficiency of introduction of the florigen.

Any substance may be added to the solution for florigen introduction as long as the substance does not reduce the efficiency of introduction of the florigen and the cell-penetrating peptide into the tissue.

The introduction method of the present invention may include the step of exposing the shoot apical tissue in order to bring the solution for florigen introduction into contact with the shoot apical tissue. When, for example, the solution for florigen introduction is added dropwise after the shoot apical tissue is exposed, the solution for florigen introduction can be brought directly into contact with the shoot apical tissue. Alternatively, the shoot apical tissue may be brought into contact with the solution for florigen introduction without exposing the shoot apical tissue by sprinkling an enough amount of the solution for florigen introduction to the vicinity of the shoot apical tissue or by injecting the solution for florigen introduction into the vicinity of the shoot apical tissue using an injector or the like. Alternatively, the solution for florigen introduction may be transported to the shoot apical tissue through the sieve tube of the plant by, for example: absorbing the solution for florigen introduction via an incision of the stem, petiole, leaf, joint, root, or the like of the plant; introducing the solution for florigen introduction based on a capillary phenomenon via a thread passed to the vicinity of the stem or shoot apical tissue; or immersing the whole of the plant in the solution for florigen introduction.

The present invention further encompasses a promotion method for flowering of a plant, which includes the method of introducing a florigen into a cell of a shoot apical tissue of a plant of the present invention. In the cell of the shoot apical tissue, the florigen is considered to be bound to 14-3-3 protein and bZIP transcription factor to forma florigen activation complex and to remain in the nucleus. When the process is started, the florigen activation complex is accumulated in the nucleus. After that, the florigen activation complex activates transcription of a flower-bud formation marker gene (for example, OsMADS15 gene) that causes induction of flowering, resulting in promoting flowering of a plant. In the promotion method for flowering of a plant of the present invention, introduction of the florigen into the shoot apical tissue causes activation of transcription of the flower-bud formation marker gene (for example, OsMADS15 gene), resulting in promoting flowering. In addition, in formation of a flower bud, expression of flowering-responsive genes such as APETALA1 (AP1) gene, FRUITFULL (FUL) gene, and SQUAMOSA PROMOTER BINDING-LIKES (SPL3) gene is induced. The expression of FUL gene is induced in the shoot apical tissue upon transition from the vegetative stage to the reproductive stage, and the expression of AP1 gene is induced in primordia of floral bud immediately after its differentiation from the shoot apical tissue in the reproductive stage. The SPL3 gene is a gene that is located genetically upstream of the AP1 gene and the FUL gene and is induced in the early stage of the flowering. In the promotion method for flowering of a plant of the present invention, the florigen is introduced into the shoot apical tissue to induce expression of the SPL3 gene, AP1 gene, and FUL gene. According to the promotion method for flowering of a plant of the present invention, transcription of the flowering marker gene and the flowering-responsive gene is activated to form a flower bud primordium in the shoot apical tissue, as compared to the case where the florigen is not introduced, resulting in promoting flowering.

The present invention further encompasses an agent for introducing a florigen into a cell of a shoot apical tissue of a plant, which includes a florigen and a cell-penetrating peptide. The agent for introducing a florigen includes preferably a solution for florigen introduction, in which the florigen and the cell-penetrating peptide are present in the same aqueous medium, more preferably a mixed solution obtained by mixing the florigen and the cell-penetrating peptide. In addition, the present invention further encompasses an agent for promoting flowering of a plant, which includes the agent for introducing a florigen.

The present invention further encompasses a kit for introducing a florigen into a cell of a shoot apical tissue of a plant, which includes a florigen and a cell-penetrating peptide. The kit may include the florigen and the cell-penetrating peptide as independent molecules or as one molecule such as a fusion protein. The kit may include an aqueous medium for mixing the florigen and the cell-penetrating peptide, or may further include another additive. In the case where the kit includes the florigen and the cell-penetrating peptide as independent molecules, the florigen and the cell-penetrating peptide may be mixed to prepare a mixed solution immediately before introduction of the florigen into a plant.

### EXAMPLES

The present invention is hereinafter described by way of Examples and Comparative Examples. However, it should be appreciated that the present invention is not limited to the description of Examples.

### Example 1

### Study on Method of Introducing Protein into Plant Tissue Cell

(1) A cell-penetrating peptide and a protein were separately prepared and mixed, and a plant tissue was treated with the mixture.

Eight kinds of cell-penetrating peptides shown in Table 1 above and GFP were separately mixed in PBS (137 mM NaCl, 2.7 mM KCl, 10 mM Na₂HPO₄, 1.76 mM KH₂PO₄) (pH 7.4) so as to achieve a final concentration of 50 μM, and rice radicles were immersed in the mixtures. The eight kinds of cell-penetrating peptides are typical peptides selected from arginine-rich peptides, amphiphilic peptides, and peptides each having an RXLR sequence, and were prepared by chemical synthesis.

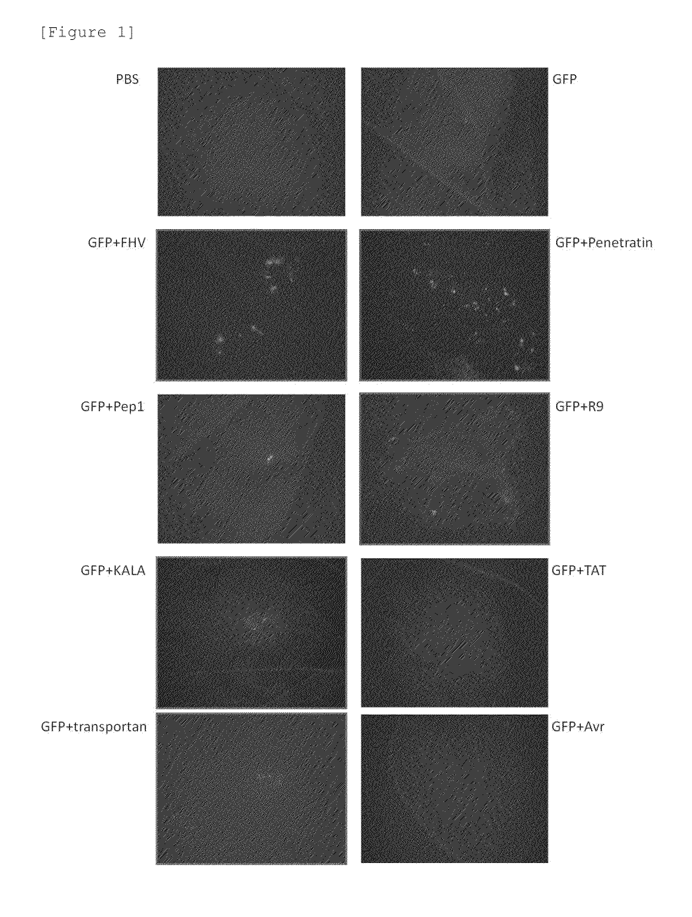

The immersion treatment was carried out for 16 hours at room temperature, followed by low-temperature treatment at 4° C. for 4 hours. The samples were washed until fluorescence was not observed in a negative control group treated with GFP alone, and cells were counted under a fluorescence stereomicroscope to calculate ratios of fluorescent cells. As a result, it was found that this method was able to efficiently introduce GFP directly into a cell of a plant (FIG. 1).

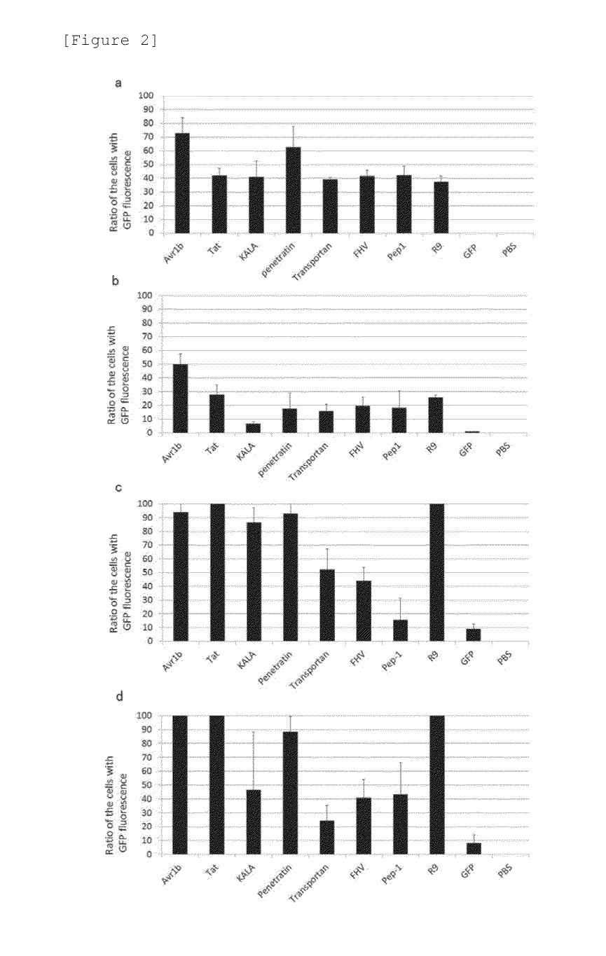

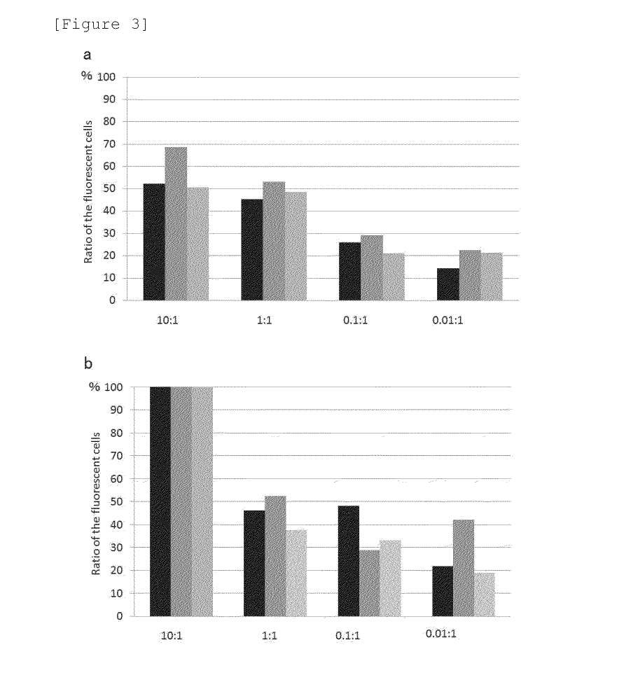

(2) The efficiency of introduction of GFP by the eight kinds of cell-penetrating peptides was examined quantitatively in the same manner as in (1) above. Rice radicles (FIG. 2a), cultured rice cells (rice protoplasts) (FIG. 2b), tobacco leaves (FIG. 2c), and Arabidopsis leaves (FIG. 2d) were used as tissues to be examined. A total of 32 treatment groups were evaluated. As a result, comprehensive efficiency of introduction by Avr1b was the highest, and the efficiency of introduction by R9 and Tat were the second highest.

(3) The effect of the molar ratios of the cell-penetrating peptides to the protein on the efficiency of introduction of the protein was examined. The molar ratios of the cell-penetrating peptides (Avr1b and R9) to the protein were changed to 0.01, 0.1, 1, and 10, and the efficiency of introduction of GFP into rice root epidermal cells was evaluated.

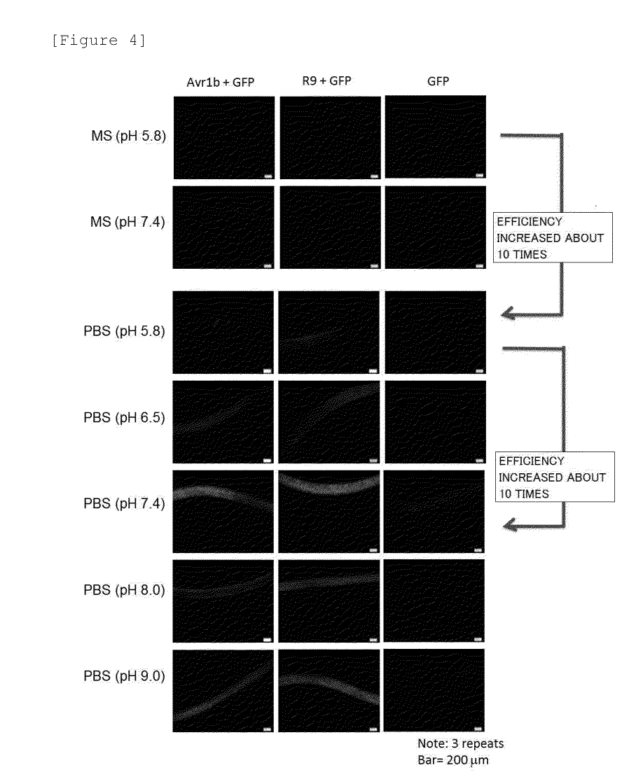

FIG. 3 show the results. FIG. 3a shows results of the test using the mixed solution of Avr1b and GFP, and FIG. 3b shows results of the test using the mixed solution of R9 and GFP. As the molar ratio of R9 increased in the order of 0.01, 0.1, 1, and 10, the introduction efficiency increased. When R9 was used at a molar ratio 10 times higher than that of the florigen, the efficiency of introduction of GFP increased 2.5 times as compared to the case of using R9 at a molar ratio of 1 times. As the molar ratio of Avr1b increased in the order of 0.01, 0.1, 1, and 10, the introduction efficiency increased although the increase rate was small as compared to R9.

(4) There was examined the effect of conditions such as the kind and pH of a medium in which the protein and the cell-penetrating peptide were mixed on the efficiency of introduction of the protein. MS media (three kinds: pH 5.8, 6.5, and 7.4) and PBS's (five kinds: pH 5.8, 6.5, 7.4, 8.0, and 9.0) were used as media to be used for treatment with the cell-penetrating peptide and the protein to examine the efficiency of direct introduction of GFP into rice radicles. The MS media were prepared using “Plant tissue medium series, Mixed salts for Murashige and Skoog medium” (manufactured by NIHON PHARMACEUTICAL CO., LTD.). The pH's of the MS media were adjusted using hydrochloric acid or an aqueous sodium hydroxide solution. In addition, as the PBS's, PBS's having the same compositions as that in Example 1 were used, and the pH's were adjusted using hydrochloric acid or an aqueous sodium hydroxide solution.

FIG. 4 show the results. In the case of using the PBS (pH 5.8), the efficiency of introduction of GFP increased 10 times as compared to the case of using the MS medium (pH 5.8). Further, in the case of using the PBS (pH 7.4), the efficiency of introduction of GFP increased 10 times as compared to the case of using the PBS (pH 5.8). Comprehensively, the highest efficiency of introduction was achieved in the case of using the PBS (pH 7.4).

### Example 2

### Search for Florigen Capable of High Level Expression

(1) Wild-type Hd3a (SEQ ID NO: 1) cannot be synthesized in a large amount under usual conditions, and hence a mutation to stabilize Hd3a and to increase the yield was introduced into Hd3a, followed by expression (see Non Patent Literature 2).

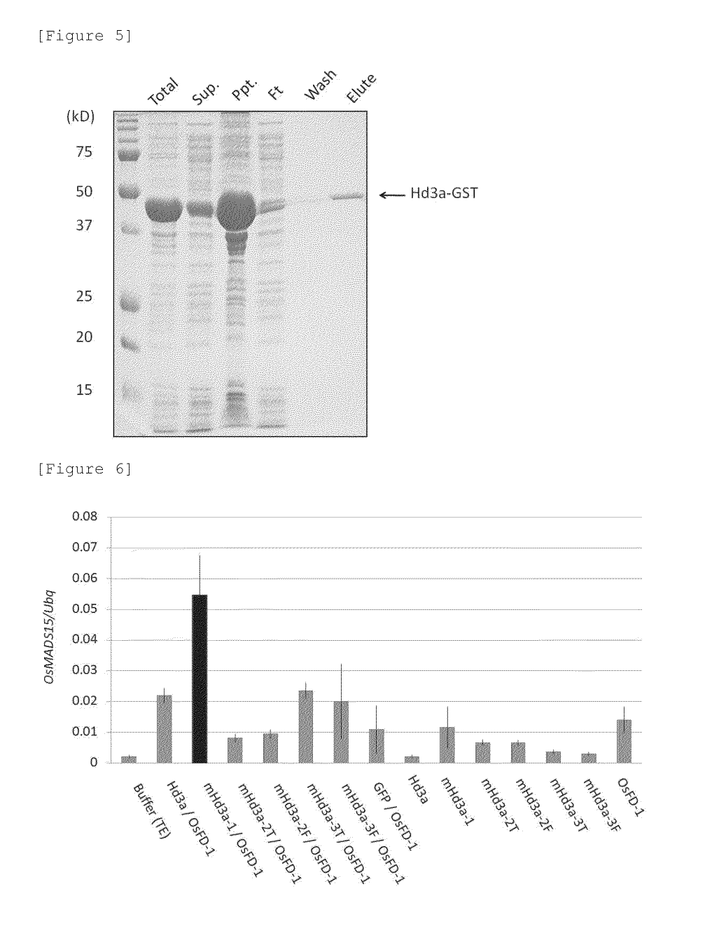

The results revealed that three kinds of florigens, i.e., mHd3a-1 (full-length, having K31A and E57A amino acid substitutions), mHd3a-2T (a partial peptide having a sequence consisting of amino acids at positions from 6 to 170, having C43L, C109S, and C166S amino acid substitutions), and mHd3a-3T (a partial peptide having a sequence consisting of amino acids at positions from 8 to 170, having K31A, Y136A, and W140A amino acid substitutions), were capable of high level expression and providing soluble fractions. FIG. 5 is a photograph showing mHd3a-1 separated and detected by SDS-PAGE through a conventional method.

(2) The florigen functions were examined for mutated Hd3a partial peptides of mHd3a-2F (full-length, having C43L, C109S, and C166S amino acid substitutions) and m-Hd3a-3F (full-length, having K31A, Y136A, and W140A amino acid substitutions) in addition to the mutated Hd3a's examined in (1) above, i.e., mHd3a-1, mHd3a-2T, and mHd3a-3T. The as say system used is a transient expression system for protoplasts. When the mutated Hd3a and a transcription factor OsFD1 are transiently expressed in protoplasts in this system, a flower-bud formation marker gene OsMADS15 is transcriptionally activated if the Hd3a is functional. The transient expression system for protoplasts was constructed according to the method described in Non Patent Literature 2. In addition, the expression of the OsMADS15 gene was examined by RT-PCR method according to the method described in Non Patent Literature 2.

The test was carried out using the mutated Hd3a's and partial peptides thereof, and the results revealed that mHd3a-1 most desirably activated transcription of the OsMADS15 gene (FIG. 6).

### Comparative Example 1

### Introduction of GFP into Cell of Rice Shoot Apical Tissue

A rice shoot apical tissue was exposed under a stereomicroscope, and a cell-penetrating peptide and GFP were separately prepared and mixed in the same manner as in Example 1 and were used for treatment of the plant tissue. A mixed solution was prepared by adding GFP at a final concentration of 50 μM and a cell-penetrating peptide R9 at a final concentration of 500 μM in PBS (pH 7.4). The mixed solution was added dropwise to the exposed shoot apical tissue to bring the mixed solution into contact with the tissue. The tissue was treated for 16 hours at room temperature.

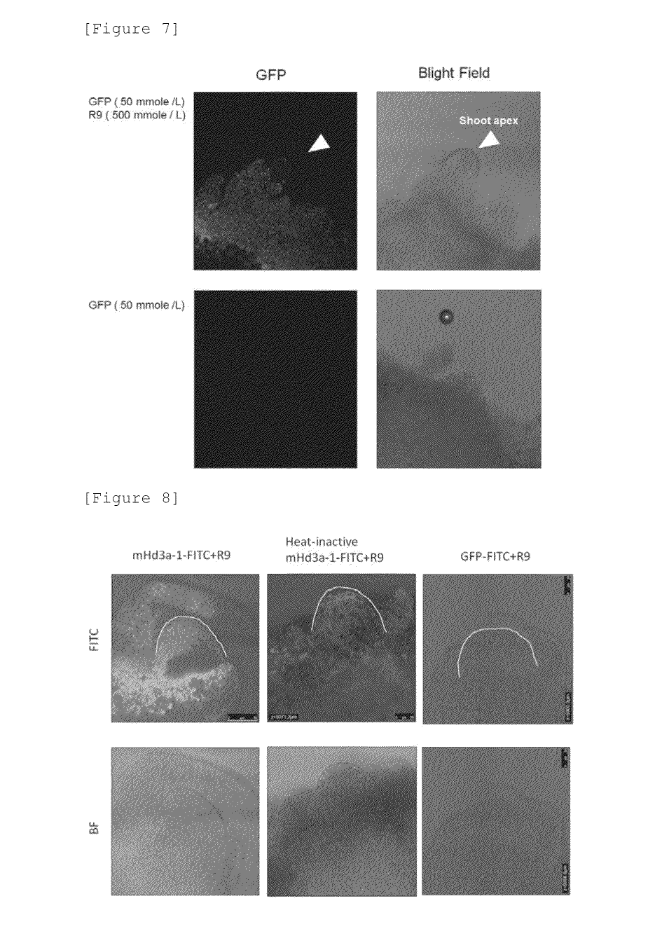

As a result, it was found that the efficiency of introduction of GFP into the shoot apex meristem was not so high (FIG. 7).

### Example 3

### Introduction of Florigen into Cell of Rice Shoot Apical Tissue

The mHd3a-1 prepared by high level expression in Example 2 was labeled with a fluorochrome FITC. Subsequently, a rice shoot apical tissue was exposed under a stereomicroscope, and the cell-penetrating peptide and the florigen were mixed and used for treatment of the plant tissue in the same manner as in Example 1. A mixed solution was prepared by adding the florigen at a final concentration of 50 μM and the cell-penetrating peptide R9 at a final concentration of 500 μM in PBS (pH 7.4). The mixed solution was added dropwise to the exposed shoot apical tissue to bring the mixed solution into contact with the tissue. The tissue was treated for 16 hours at room temperature.

The results revealed that the mHd3a-1 was introduced efficiently into the rice shoot apical tissue (FIG. 8). The results further revealed that the mHd3a-1 was localized accurately in the nucleus serving as a functional site of the florigen in the cell of the shoot apical tissue.

### Example 4

### Introduction of Florigen into Cells of Shoot Apical Tissues of Corn and Arabidopsis

In the same manner as in Example 3, the mixed solution of the cell-penetrating peptide and the florigen was added dropwise to shoot apical tissues of corn and Arabidopsis to treat the tissues.

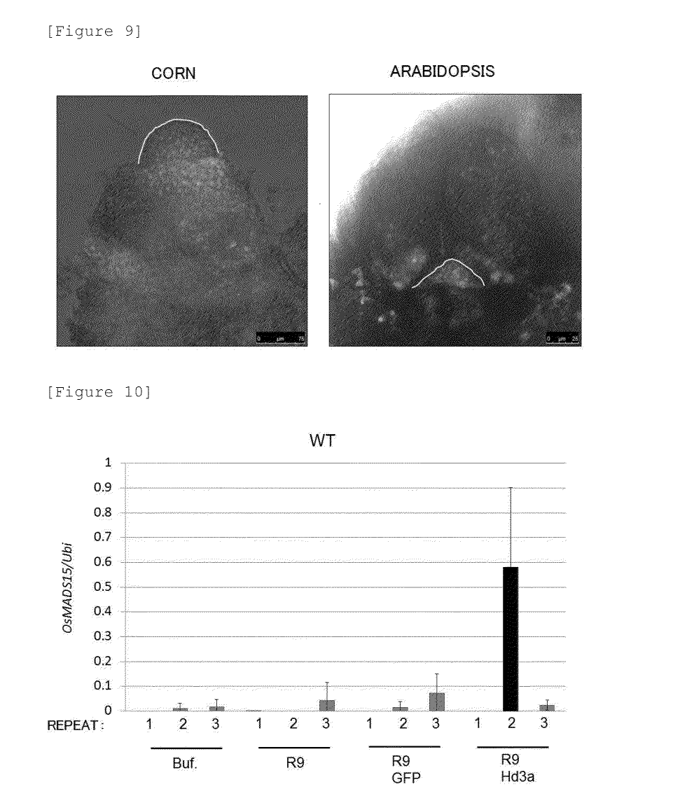

The results revealed that the mHd3a-1 was introduced efficiently into the shoot apical tissues of corn and Arabidopsis (FIG. 9). The results further revealed that the mHd3a-1 was localized accurately in the nucleus serving as a functional site of the florigen in the cell of the shoot apical tissue.

### Example 5

### Examination of Effect of Direct Introduction of Florigen on Expression of Flower-Bud Formation Marker Gene

(1) A rice shoot apical tissue into which the florigen was introduced was isolated in the same manner as in Example 3. RNA was extracted from the rice shoot apical tissue by a conventional method, and expression of a flower-bud formation marker gene (OsMADS15 gene) was examined by real-time quantitative RT-PCR (see Non Patent Literature 2 for the method).

The results revealed that direct introduction of the florigen into the shoot apical tissue can activate expression of the flower-bud formation marker gene (OsMADS15 gene) (FIG. 10).

(2) Further, rice in which all florigens were inactivated (Hd3a-RFT1 double RNAi) (Komiya et al. (2008) Development 135:767-774) was subjected to the same experiment as in (1). Rice has two florigen genes (Hd3a and RFT1), and flower bud-forming ability is completely lost in the rice in which expression of both the genes has been simultaneously suppressed (Hd3a-RFT1 double RNAi). Therefore, the rice usually exhibits almost no expression of the flower-bud formation marker gene.

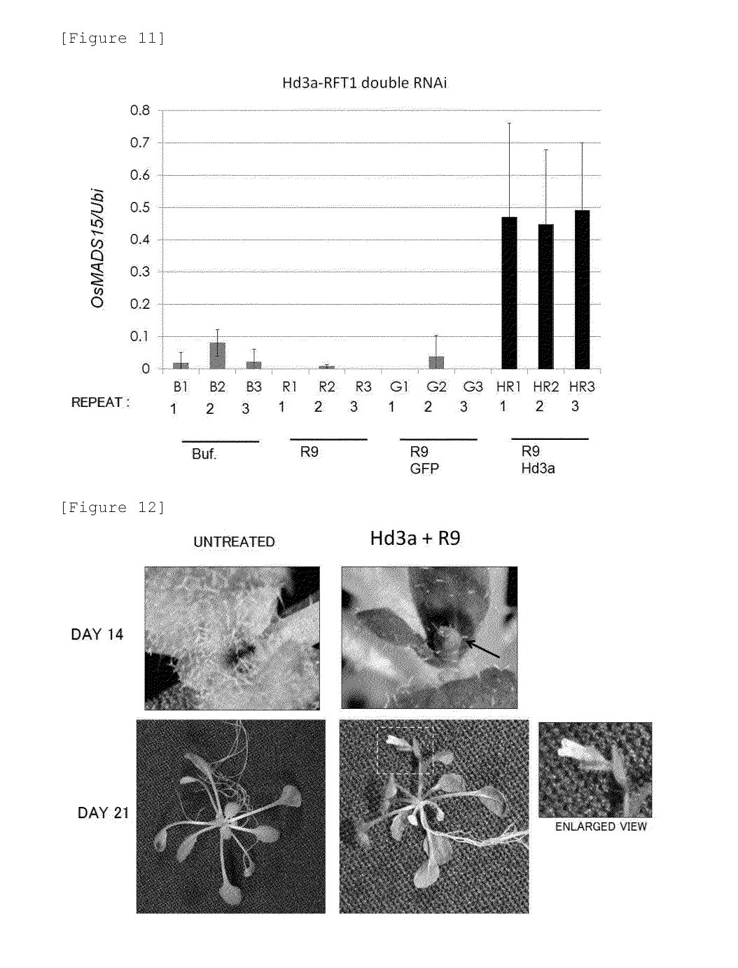

It was found that direct introduction of the florigen even into the rice in which all florigens were inactivated (Hd3a-RFT1 double RNAi) could activate the expression of the flower-bud formation marker gene (FIG. 11).

### Example 6

### Examination of Flowering-Promoting Effect in Plant Body into which Florigen has been Directly Introduced

A mixed solution prepared by mixing the florigen mHd3a-1 and the cell-penetrating peptide R9 in ten-times diluted PBS in the same manner as in Example 3 was used for treatment of seedling of Arabidopsis at the time of cotyledon expansion about three days after seeding. It should be noted that the shoot apices in seedling of Arabidopsis was exposed at the time of cotyledon expansion. The treatment was carried out at room temperature for 2 days. After that, the mixed solution was washed, and the plants were cultivated on the MS medium under a short-day condition (day length: 10 hours) for from 30 to 40 days to examine the timing of the flowering. The examination condition of the start of the flowering was defined as the start of bolting or a state where differentiation of flower buds was visually observed, and whether the flowering was early or late was evaluated based on the number of rosette leaves at the time when the state described above was achieved. In the case of Arabidopsis, rosette leaves are usually extracted, and the extraction of the rosette leaves is stopped when the flowering is started. When the flowering is started in the early stage, the number of the leaves is small because only a small number of the rosette leaves can be extracted, while when it takes a long time before the flowering is started, the number of the leaves is large because many rosette leaves can be extracted.

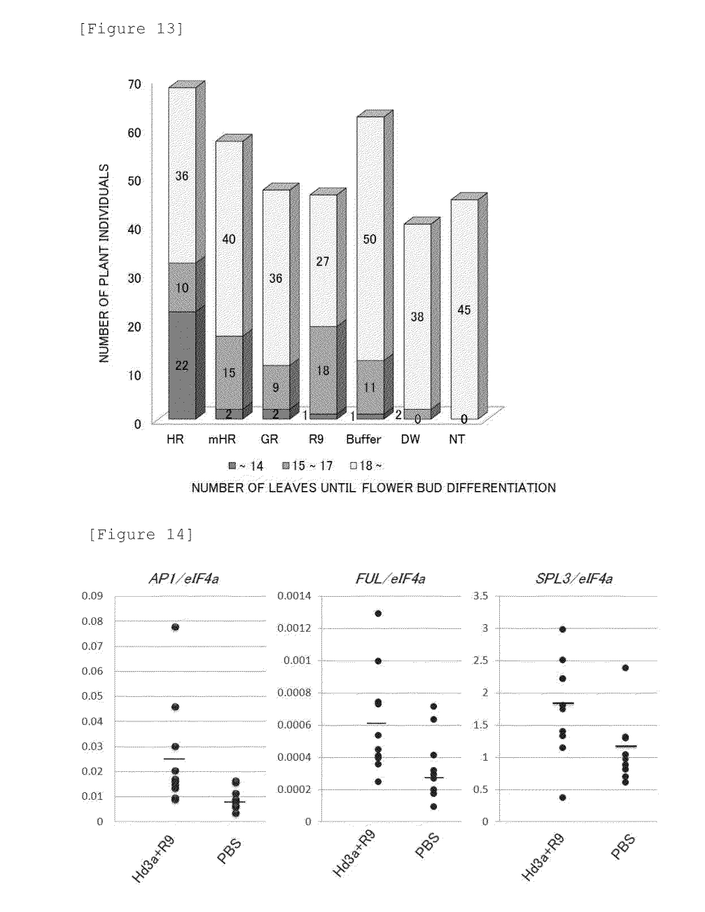

FIG. 12 and FIG. 13 show the results. FIG. 12 are photographs taken on day 14 and day 21, when the cultivation start date under the short-day condition is defined as day 0. The enlarged view is one obtained by enlarging the area enclosed by a dashed line in the photograph of a flower bud of an individual treated with the mixed solution of mHd3a-1 and R9, which was taken on day 21. In addition, the numbers in the graph of FIG. 13 represent numbers of individuals that achieved the flowering at each number of leaves. In FIG. 13, “HR” represents results of treatment with the mixed solution of mHd3a-1 and R9, “mHR” represents results of treatment with the mixed solution of mutated Hd3a incapable of being bound to a receptor (specifically, Hd3a R64D F103A R132D) and R9, “GR” represents results of treatment with the mixed solution of GFP and R9, “R9” represents results of treatment with a solution containing R9 alone, “Buffer” represents results of treatment with PBS alone, “DW” represents results of treatment with distilled water, and “NT” represents results of no treatment.

Almost all the untreated plants were not able to start the flowering under the conditions of this example. However, in the case of the treatment with mHd3a-1 and R9, about 30% of the plants were able to start the flowering when the number of the leaves was 14 or less. Even when the plants were treated with mutated Hd3a (mHR) incapable of being bound to a receptor or GFP instead of mHd3a-1, the effect of promoting the start of the flowering was not observed. Almost all the plants treated with R9 alone, PBS alone, and distilled water alone did not start the flowering when the number of the leaves was 14 or less. The results of the experiments revealed that direct introduction of the florigen into Arabidopsis could promote the flowering.

### Example 7

### Examination of Effect on Induction of Expression of Flowering-Responsive Gene in Arabidopsis into which Florigen has been Directly Introduced

The florigen was introduced directly into Arabidopsis in the same manner as in Example 6, and then the plants were cultivated for 2 weeks, followed by collection of a shoot apical tissue from each individual. RNA was extracted from the shoot apical tissue collected from each individual, and cDNA was synthesized based on a reverse transcription reaction. After that, the expression levels of APETALA1 (AP1) gene, FRUITFULL (FUL) gene, and SQUAMOSA PROMOTER BINDING-LIKES (SPL3) gene were examined by real-time quantitative RT-PCR (see Yamaguchi et al. Dev. Cell 17:268-278 (2009)).

The results revealed that direct introduction of the florigen activated the expression of the three genes (FIG. 14). Induction of the expression was observed in about 30% of the individuals treated, and the results corresponded to the ratio of the plants in which flowering was promoted in Example 6. It should be noted that eIF4a was used as an internal standard. In addition, the horizontal lines in FIG. 14 represent average values.

### INDUSTRIAL APPLICABILITY

According to the present invention, it is possible to alter the timing of flowering of a plant by using the solution for florigen introduction. The alteration of the timing of flowering of a plant is very useful in the fields of, for example, cultivation management and cultivar improvement of plants. The present invention can be carried out easily and can be applied to many plant species, and hence is expected to be put into practical use in the fields of plant breeding, cultivation of plants, biomass, and the like.

1. A method of introducing a florigen into a cell of a shoot apical tissue of a plant using a cell-penetrating peptide.

2. An introduction method according to claim 1, wherein the cell-penetrating peptide is selected from a peptide including from 8 to 12 consecutive arginine residues and a peptide having an RXLR sequence.

3. An introduction method according to claim 1, wherein the florigen comprises a mutated florigen having an amino acid sequence set forth in SEQ ID NO: 1 with a substitution of at least one amino acid selected from amino acids corresponding to lysine at position 31, cysteine at position 43, glutamic acid at position 57, cysteine at position 109, tyrosine at position 136, tryptophan at position 140, and cysteine at position 166, or a partial peptide thereof.

4. An introduction method according to claim 1, wherein the florigen comprises a mutated Hd3a protein having an amino acid sequence set forth in SEQ ID NO: 1 with a substitution of from 1 to 10 amino acids, or a partial peptide thereof.

5. An introduction method according to claim 1, wherein the florigen is selected from the following mutated florigens (1) to (5):
(1) a mutated Hd3a having an amino acid sequence set forth in SEQ ID NO: 1 with substitutions of lysine at position 31 and glutamic acid at position 57;
(2) a mutated Hd3a having an amino acid sequence set forth in SEQ ID NO: 1 with substitutions of cysteine at position 43, cysteine at position 109, and cysteine at position 166;
(3) a partial peptide of the mutated Hd3a described in (2), which includes a sequence of amino acids at from position 6 to position 170 in the amino acid sequence set forth in SEQ ID NO: 1;
(4) a mutated Hd3a having an amino acid sequence set forth in SEQ ID NO: 1 with substitutions of lysine at position 31, tyrosine at position 136, and tryptophan at position 140; and
(5) a partial peptide of the mutated Hd3a described in (4), which includes a sequence of amino acids at from position 8 to position 170 in the amino acid sequence set forth in SEQ ID NO: 1.

6. An introduction method according to claim 1, comprising the step of bringing a mixed solution obtained by mixing the florigen and the cell-penetrating peptide in an aqueous medium into contact with the shoot apical tissue of the plant.

7. An introduction method according to claim 6, wherein a molar ratio of the florigen and the cell-penetrating peptide in the mixed solution is from 1:1 to 1:50.

8. An introduction method according to claim 6, wherein the aqueous medium has a pH of from 6.5 to 8.0.

9. An introduction method according to claim 6, wherein the aqueous medium comprises phosphate buffered saline (PBS).

10. A promotion method for flowering of a plant, the promotion method comprising carrying out the method according to claim 1.

11. An agent for introducing a florigen into a cell of a shoot apical tissue of a plant, the agent comprising:
a florigen; and
a cell-penetrating peptide.

12. An agent for introducing a florigen according to claim 11, wherein the agent comprises a mixed solution obtained by mixing the florigen and the cell-penetrating peptide in an aqueous medium.

13. An agent for promoting flowering of a plant, the agent comprising the agent for introducing a florigen according to claim 11.

14. A kit for introducing a florigen into a cell of a shoot apical tissue of a plant, the kit comprising:
a florigen; and
a cell-penetrating peptide.


SEQUENCE LISTING (22 sequences)

SEQ ID NO: 1 - protein, 179 aa, Oryza sativa
MAGSGRDRDPLVVGRVVGDVLDAFVRSTNLKVTYGSKTVSNGCELKPSMVTHQPRVEVGGNDMRTFYTLVMVDPDAPSPSDPNLREYLHWLVTDIPGTTAASFGQEVMCYESPRPTMGIHRLVFVLFQQLGRQTVYAPGWRQNFNTKDFAELYNLGSPVAAVYFNCQREAGSGGRRVYP

SEQ ID NO: 2 - protein, 11 aa, Artificial Sequence
  Membrane-permeable peptide Tat
YGRKKRRQRRR

SEQ ID NO: 3 - protein, 15 aa, Artificial Sequence
  Membrane-permeable peptide FHVcoat
RRRRNRTRRNRRRVR

SEQ ID NO: 4 - protein, 21 aa, Artificial Sequence
  Membrane-permeable peptide Pep-1
KETWWETWWTEWSQPKKKRKV

SEQ ID NO: 5 - protein, 16 aa, Artificial Sequence
  Membrane-permeable peptide Penetratin
RQIKIWFQNRRMKWKK

SEQ ID NO: 6 - protein, 27 aa, Artificial Sequence
  Membrane-permeable peptide Transportan
GWTLNSAGYLLGKINLKALAALAKKIL

SEQ ID NO: 7 - protein, 9 aa, Artificial Sequence
  Membrane-permeable peptide R9
RRRRRRRRR

SEQ ID NO: 8 - protein, 30 aa, Artificial Sequence
  Membrane-permeable peptide KALA
WEAKLAKALAKALAKHLAKALAKALKACEA

SEQ ID NO: 9 - protein, 45 aa, Artificial Sequence
  Membrane-permeable peptide Avr1b
TEYSDETNIAMVESPDLVRRSLRNGDIAGGRFLRAHEEDDAGERT

SEQ ID NO: 10 - protein, 16 aa, Artificial Sequence
  Membrane-permeable peptide p-Antp
RQIKIWFQNRRMKWKK

SEQ ID NO: 11 - protein, 17 aa, Artificial Sequence
  Membrane-permeable peptide gp41
GALFLGFLGAAGSTMGA

SEQ ID NO: 12 - protein, 7 aa, Artificial Sequence
  Membrane-permeable peptide SV40NLS
PKKKRKV

SEQ ID NO: 13 - protein, 34 aa, Artificial Sequence
  Membrane-permeable peptide VP22
DAATATRGRSAASRPTERPRAPARSASRPRRPVD

SEQ ID NO: 14 - protein, 15 aa, Artificial Sequence
  Membrane-permeable peptide Integrinbeta3
VTVLALGALAGVGVG

SEQ ID NO: 15 - protein, 30 aa, Artificial Sequence; identical to SEQ ID NO: 8
  Membrane-permeable peptide InfluenzaHA-2

SEQ ID NO: 16 - protein, 21 aa, Artificial Sequence
  Membrane-permeable peptide BMV-gag
KMTRAQRRAAARRNRWTARGC

SEQ ID NO: 17 - protein, 13 aa, Artificial Sequence
  Membrane-permeable peptide HTLV-II Rex
TRRQRTRRARRNR

SEQ ID NO: 18 - protein, 9 aa, Artificial Sequence
  Membrane-permeable peptide R/W
RRWWRRWRR

SEQ ID NO: 19 - protein, 28 aa, Artificial Sequence
  Membrane-permeable peptide Human c Fos
KRRIRRERNKMAAAKSRNRRRELTDTGC

SEQ ID NO: 20 - protein, 30 aa, Artificial Sequence
  Membrane-permeable peptide Human c Jun
RIKAERKRMRNRIAASKSRKRKLERIARGC

SEQ ID NO: 21 - protein, 24 aa, Artificial Sequence
  Membrane-permeable peptide Yeast GCN 4
KRARNTEAARRSRARKLQRMKQGC

SEQ ID NO: 22 - protein, 17 aa, Artificial Sequence
  Membrane-permeable peptide Rev
TRQARRNRRRRWRERQR